(19) United States
(12) Patent Application Publication
(10) Pub. No.: US 2003/0121421 A1
(43) Pub. Date: Jul. 3, 2003

(54) Far infrared uniform-heating cookware

(76) Inventor: Albert C. Wey, Westmont, IL (US)

Correspondence Address: Albert C. Wey, 233 E. 57th Street, Westmont, IL, 60559, US

(21) Appl. No.: 10/034,612

(22) Filed: Dec. 28, 2001

(51) Int. Cl. A47J 37/12

(52) U.S. Cl. 99/403

(57) ABSTRACT

This invention relates to a uniform-heating cookware, which serves to bake, to boil, to fry, or to stir fry, comprising a thin layer of far infrared radiation material coated on the food-contacting surface of a conventional cooking utensil such as a pan, a wok, a pot, or the like. The said far infrared radiation layer serves as a highly efficient transducer that transfers heat and the associated near infrared radiation from the heating source into longer-wavelength far infrared radiation and thereby alters its heat distribution profile. It provides a way of uniform heating of food, without a worry of burning food even if the food is in direct contact with the layer at heating surface. Furthermore, the device of the present invention can uniformly cook frozen foods at no requirement of defrosting. It therefore shortens cooking time and saves energy.

### BACKGROUND—FIELD OF INVENTION

This invention relates to a uniform-heating cookware, which serves to bake, to boil, to fry, or to stir fry, comprising a thin layer of far infrared radiation material coated on the food-contacting surface of a conventional cooking utensil such as a pan, a wok, a pot, or the like. The said far infrared radiation layer serves as a highly efficient transducer that transfers heat and the associated near infrared radiation from the heating source into longer-wavelength far infrared radiation and thereby alters its heat distribution profile. It provides a way of uniform heating of food, without a worry of burning food even if the food is in direct contact with the layer at heating surface. Furthermore, the device of the present invention can uniformly cook frozen foods at no requirement of defrosting. It therefore shortens cooking time and saves energy.

### BACKGROUND—DESCRIPTION OF PRIOR ART

There are numerous cooking devices developed to utilize far infrared radiation for uniform heating. However, all they require being made up of fragile, bulky far infrared radiating ceramic materials. For instance, the invention as described in U.S. Pat. No. 6,261,985 demands a prescribed 5%-10% weight-ratio in far infrared radiation material for the intended purpose. Some inventions may employ an external far infrared radiation heater (e.g. U.S. Pat. No. 6,293,186) for uniform heating. Unfortunately, far infrared rays can not penetrate metallic containers or utensils so that the utility of such devices may be limited. In spite of that, none has revealed the possibility of using a thin layer of far infrared radiation material for uniform heating.

A prior art (U.S. Pat. No. 5,943,950) discloses the application of coating a film of titanium oxide on utensils for table use and cooking use. Nevertheless, it involves photocatalytic reaction and purposes for improving the taste of food and drink. After all, none of the prior arts teaches the use of a thin far infrared radiation layer in the application as described herein.

It is known that far infrared radiation in a wavelength band 3-20 μm has a strong resonance effect to substance having intermolecular bonding. As described in Organic Chemistry, there exist dipole-dipole interactions between polarized molecules and hydrogen-bonding is one of the strongest. The electric potentials of such dipole-dipole interactions are measured to be in the range of 0.04-0.5 eV (electric volt). Based on a simplified equation that governs the relationship between electric potential (eV) and the photon energy E associated with a wavelength λ (μm):

λ(μm)=1.2398(eV−μm)/E(eV),

such dipole-dipole interactions will resonate with electromagnetic waves having wavelengths between 2.5 μm and 30 μm, which happen to fall in the far infrared radiation zone.

For example, water molecule (H₂O) consists of two hydrogen (H) atoms and one oxygen (O). The angle formed by the two oxygen-hydrogen (O—H) chemical bonds in water molecule is 104 degrees so that water molecule is polarized in nature. It means that hydrogen and oxygen atoms in water are charged and inclined to create static bonding (so-called Hydrogen-Bonding) between water molecules. As a result, the charged water molecules gather and form clusters thanks to hydrogen-bonding. The electric potential of the intermolecular hydrogen-bonding is computed to be about 0.35 eV. Accordingly, this can be resonantly overcome with a radiation at about 3.54 μm wavelength.

It is also known that a 6.27 μm wavelength far infrared radiation can activate water molecule by transferring photon energy into symmetrical rotation of atoms within the molecule. Consequently, water is a good absorbent of far-infrared radiation at wavelengths 3.54 um and 6.27 um. The photon energies of far-infrared radiation at these wavelengths are absorbed by clustered water molecules and used to break apart the clusters and also to charge up the separated molecules.

Furthermore, several chemical bonds in organic and inorganic compounds can also be resonantly activated by far infrared radiation. They absorb photon energy and then transfer it into activation energy for vibration, rotation, or angular movement. They may be summarized as follows:

| Bond | IR Absorption Band |
|---|---|
| N—H | 2.8-3.3 μm |
| C—H | 3.2-3.6 μm |
| S—H | 3.8-3.9 μm |
| P—H | 4.1-4.3 μm |
| C≡C | 4.4-4.8 μm |
| C═C | 5.9-6.3 μm |
| C═O | 5.4-6.1 μm |
| N═O | 5.7-6.3 μm |
| C—F | 7.1-10.0 μm |
| C—X | 12.8-20.0 μm |

In summary, the photon energies from far infrared radiation can resonantly increase the temperature inside of the heated objects containing organic compounds that consist with aforementioned covalent bonds, in a similar fashion as in a microwave oven. Therefore, the key element in this invention is the development of a high radiation capacity material so that a thin layer of such material can achieve the purposed application, which would otherwise only be accomplished by fragile, bulky materials as described in prior arts.

The present inventor has undertaken extensive studies to select a far infrared radiation material that possesses a strong radiation capacity in the desirable band of wavelengths, namely 3 to 20 μm. As a result, the inventor found that the far infrared radiating material fabricated by the method involving inorganic powders having particle sizes smaller than 3,000 angstroms provided a larger radiation effect that could be attributed to larger specific radiation surface areas of the particles.

The inventor further found that only those far infrared radiation material comprising mixtures of compounds having ultrafine powders in smaller particle sizes, preferably below 200 angstroms, would emit considerable radiation and provide significant activation energy even in a form of thin film.

The far infrared radiation materials are typically composed of oxides selected from the group consisting alumina, silica, alumina hydrate, silica hydrate, zirconia, lithium oxide, magnesium oxide, calcium oxide, titanium oxide, or a mixture of said oxides. Furthermore, a small amount of transition metal oxides can be added to the mixture to dramatically improve radiation strength.

Therefore, this invention relates to a uniform-heating cookware comprising a thin layer of far infrared radiating material that can be coated on any traditional metallic or nonmetallic cooking utensil. The said layer alters heat distribution profile of the heating source in such a way that the device of the present invention may uniformly heat innards of food similar to a microwave oven. It can also shield fiery heat and the associated near infrared rays from burning food at the heating surface. Correspondingly, it provid it it provides arm-heating of frozen food at no requirement of defrosting.

Objects and Advantages

Accordingly, one object of this invention is to provide a uniform-heating cookware.

Another object of the present invention is to provide a cookware, which serves to bake, to fry, to boil, or to stir fry frozen food at no requirement of defrosting.

A further object of the present invention is to provide a simple, easy-to-use, uniform-heating cookware.

Still another object of the present invention is to provide an easy-to-make, uniform-heating cookware.

These objectives are achieved by a uniform-heating cookware comprising a thin layer of far infrared radiating material, made of ultrafine far infrared radiating particles, with the said layer being coated on the food-contacting surface of any conventional cookware.

Other objects, features and advantages of the present invention will hereinafter become apparent to those skilled in the art from the following description.

### DRAWING FIGURES

FIG. 1 shows a schematic view illustrating one embodiment of the present invention with a layer of far infrared radiation material being coated over the entire inner surface of a conventional pan, topped by a coating of non-sticking material.

FIG. 2 shows a schematic view illustrating another embodiment of the present invention with a far infrared radiation layer being coated only on the heating area of a conventional pan, topped by a coating of non-sticking material.

FIG. 3 shows a schematic view illustrating another embodiment of the present invention with a far infrared radiation layer being coated on the entire inner surface of a conventional pot, topped by a coating of non-sticking material.

### REFERENCE NUMERALS IN DRAWINGS

11 Conventional cookware

12 Layer of far infrared radiation material

13 Layer of non-sticking/protection material

### SUMMARY

In accordance with the present invention, a uniform-heating cookware comprises a thin layer of far infrared radiation material made of ultrafine far infrared radiating powders disposed on the food contacting surface of a conventional cooking utensil which serves to bake, to boil, to stir fry, or to fry. The said far infrared radiation layer alters heat distribution of the heating source and thereby provides a way of uniform heating of food, without a worry of burning food even if the food is in direct contact with the heating surface. Furthermore, the device of this invention can uniformly cook frozen foods at no requirement of defrosting.

### DETAILED DESCRIPTION OF THE INVENTION

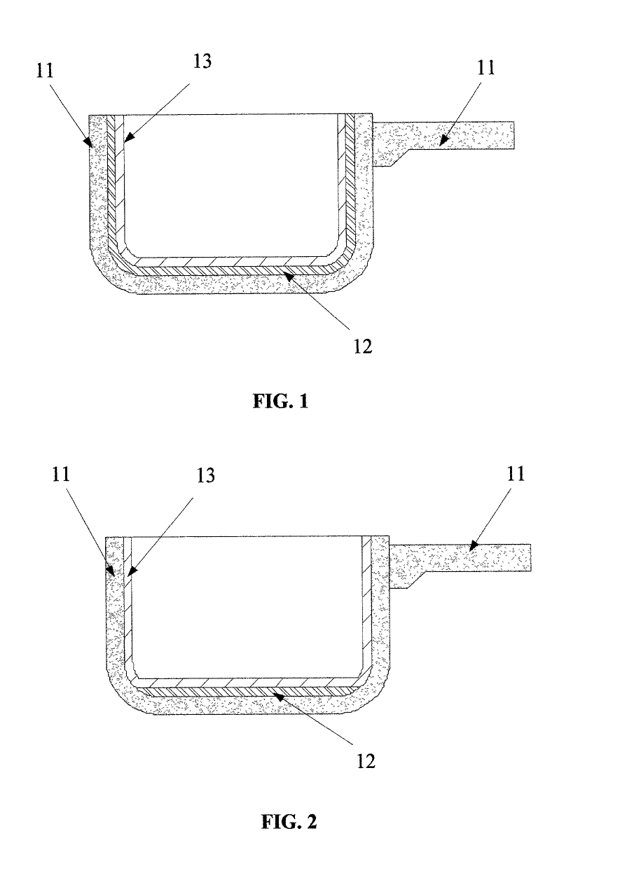

FIG. 1 illustrates one embodiment of the present invention in a form of a conventional fry pan or stir-fry wok, 11. The pan can be a made of metallic or non-metallic material. The pan is coated entirely with a thin layer of far infrared radiating material 12.

The far infrared radiating materials are typically composed of oxides selected from the group consisting alumina, silica, alumina hydrate, silica hydrate, zirconia, lithium oxide, magnesium oxide, calcium oxide, titanium oxide, or a mixture of said oxides.

The far infrared radiating material possesses a strong radiation capacity in the desirable band of wavelengths, namely 3 to 20 μm and is made of ultrafine powders having particle sizes smaller than 3,000 angstroms. The far infrared radiation material may be further processed to form particles having resultant sizes in microns for ease of coating.

A non-sticking layer, 13, may be coated on top of the said far infrared radiating layer, 12 to prevent food from sticking to the cookware. The non-sticking layer is often made of polytetrafluoroethylene (PTFE), or so-called Teflon.

FIG. 2 shows a similar embodiment of the present invention as FIG. 1, yet with a far infrared radiation layer, 12, partially coated only over the heating area of the pan where the heat and its associated near infrared rays from heating source are the strongest.

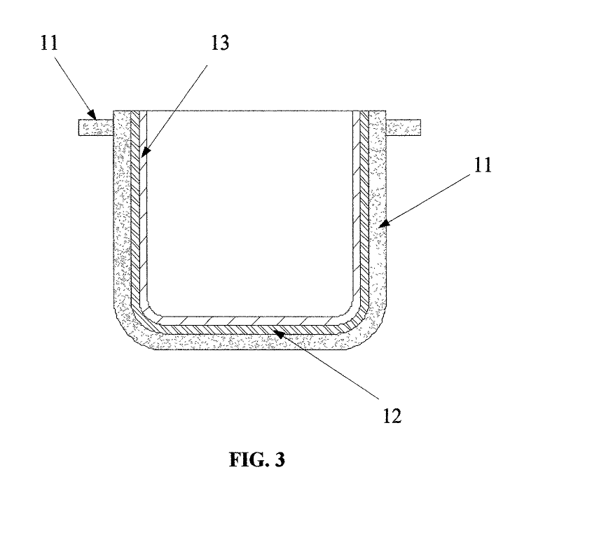

FIG. 3 shows a schematic view illustrating another embodiment of the present invention with a far infrared radiation layer, 12, coated on the entire inner surface of a conventional pot, 11, again topped by a non-sticking material coating, 13.

Other embodiments of the present invention may also include coating the said far infrared radiation layer entirely or partially on the food-contacting surface of any conventional cookware that serves to bake, to boil, to fry, or to stir fry.

### EXAMPLE

A commercially available ceramic composition that had a particle size around 3,000 angstroms and a wavelength band between 3 μm and 20 μm was chosen. The material was then submerged in certain chemical solutions to further downgrade the particle sizes to around 200 angstroms. The material was further mixed with resins and processed to have a resultant particle size in microns. The finished particles were used to coat on a fry pan. The thickness of the far infrared material layer, 12, was about 4 mils, topped by a 2-mil thick Teflon layer, 13. For demonstration, a frozen steak was placed on the said pan to be heated by a conventional gas burner. As a result, it took less time to cook the steak, compared to using a regular pan. Meanwhile, the steak was uniformed cooked, without burning the side of the steak that contacted heating surface.

In another demonstration, the finished particles were also coated on a small metallic bake tray to form a far infrared uniform-heat bake tray. Two sweet potatoes were used for comparison. One sweet potato was placed on a conventional bake tray, while the other was placed on the far infrared uniform-heat tray. Both were then placed in a conventional oven that had been heated up to 400 degrees. After a short while, the skin of the sweet potato on a conventional tray had been burnt while the inside of the sweet potato remained raw. In contrast, the skin of the sweet potato on the tray of the present invention looked intact. However, when it was cut into two halves, one might easily find that the sweet potato was completely and uniformly cooked.

Conclusion, Ramifications, and Scope

According to the present invention, a uniform-heating cookware comprising a layer of far infrared radiation material made of ultrafine far infrared radiation particles having a particle size smaller than 3,000 angstroms, preferably 200 angstroms or smaller, can uniformly heat up food with its far infrared radiation.

The invention has been described above. Obviously, numerous modifications and variations of the present invention are possible in light of the above teachings. Such variations are not to be regarded as a departure from the spirit and scope of the invention and all such modifications as would be obvious to one skilled in the art are intended to be included within the scope of the following claims.

I claim:

1. A far infrared uniform-heating cookware comprising:
a conventional cookware selected from the group consisting of pan, pot, or wok, which serves to bake, to boil, to fry, or to stir fry, and
a thin layer of far infrared radiation material coated on the said cookware.

2. A device according to claim 1 wherein said far infrared radiation material are selected from the group consisting of alumina, silica, alumina hydrate, silica hydrate, zirconia, lithium oxide, magnesium oxide, calcium oxide, titanium oxide, or a mixture of said oxides.

3. A device according to claim 1 wherein said far infrared radiation material are made of far infrared radiation particles having a radiation capacity in the band of wavelengths between 3 and 20 microns.

4. A device according to claim 1 wherein said far infrared radiation material are made of ultrafine far infrared radiation particles having a particle size 3,000 angstroms or below.
